(19) United States
(12) Patent Application Publication
(10) Pub. No.: US 2019/0162276 A1
(43) Pub. Date: May 30, 2019

(54) TENSIONING DEVICE FOR A TRACTION DRIVE

(71) Applicant: Muhr und Bender KG, Attendom (DE)

(72) Inventors: Michal Svamberk, Zajecov (CZ); Josef Justra, Most (CZ); Simon Pfeifer, Plettenberg (DE); Roland Dolle, Lennestadt (DE)

(21) Appl. No.: 16/182,698

(22) Filed: Nov. 7, 2018

(30) Foreign Application Priority Data
Nov. 29, 2017 (DE) 102017128280.7

(51) Int. Cl. F16H 7/12; F16H 7/02; F16C 33/76

(52) U.S. Cl. CPC F16H 7/1281; F16H 2007/0842; F16C 33/76; F16H 7/02

(57) ABSTRACT

A tensioning device for a traction drive comprises: a base body, a tensioning arm pivotably mounted about a pivot axis relative to the base body by a radial bearing, wherein one of the base body and tensioning arm has an annular carrier portion axially supported relative to the other of the tensioning arm and base body by a first axial bearing in a first direction and by a second axial bearing in a second direction, a first sealing element connected to said support portion for sealing said first axial bearing, a second sealing element connected to said support portion for sealing said second axial bearing, wherein the first and second axial bearings are made of a different material than the first and second sealing elements, spring means via which the tensioning arm is supported in the circumferential direction against the base body, and a tensioning roller which is rotatably mounted on the tensioning arm and serves to tension a traction means, wherein the first sealing element and the second sealing element are connected to one another by a plurality of connecting webs that extend through bores in the carrier portion.

### CROSS-REFERENCE TO RELATED APPLICATIONS

This application claims priority to German Application No. DE 10 2017 128 280.7, filed on Nov. 29, 2017, which application is hereby incorporated herein by reference in its entirety.

### BACKGROUND

In conventional traction drives, auxiliary units are designed as consumers, i.e. they are driven by the traction pulley of the crankshaft via the traction means. In this case, an undriven portion (slack side) is formed between the crankshaft and the unit adjoining in the direction of rotation of the traction means, usually the generator. In order to ensure a sufficient wrap of the tensioning means around the traction pulley, the tensioning means is pretensioned by a tensioning element of a tensioning device. Such a tensioning device is shown for example in EP 2 573 423 B9.

A further tensioning device for a belt drive with a tensioning arm is known from WO 2014/090417. The tensioning device comprises a housing part which is attached to a generator housing and forms an annular space. A ring-shaped tensioning element is rotatably mounted in the annular space of the housing part with a slide bearing and is torque-biased by a flat coil spring, so that a tensioning roller rotatably mounted on the tensioning element pretensions the belt. The front sides of the tensioning element are coated with a polymer and designed as slide bearings. The polymer coating merges from the slide bearing to two opposite sealing lips, which are in contact with the inner faces of the annular space and seal the slide bearings against environmental influences.

From EP 3 023 670 B1 a tensioning device for a belt drive with a starter generator is known. The tensioning device has a housing in which two tensioning arms are pivotable mounted about a common pivot axis. The tensioning arms are supported against each other by spring means. Sealing elements are arranged between an outer axial washer of the base body and a first tensioning arm, the first tensioning arm and a second tensioning arm, as well as between the second tensioning arm and a flange portion to seal the bearing arrangement.

### SUMMARY

Disclosed herein is a tensioning device for a traction drive which is easy to assemble and ensures a long operational lifetime, especially of the sealing system and the bearing arrangement. The tensioning device comprises an endless traction means and at least two traction pulleys, one of which can act as a drive and one as an output of the traction drive. Such traction drives are used in particular on combustion engines of a motor vehicle for driving auxiliary units (accessories), wherein a first traction pulley sits on the crankshaft of the combustion engine and drives the traction means. Further traction pulleys are assigned to the auxiliary units, such as water pumps, alternators or air conditioning compressors, and are rotatably driven by the traction drive. Usually belts or chains are used as traction means and the traction pulleys are formed complementary thereto.

A tensioning device for a traction drive is proposed, comprising: a base body, a tensioning arm which is mounted pivotable about a pivot axis relative to the base body by means of a radial bearing, wherein one of the base body and the tensioning arm has an annular carrier portion which is axially supported relative to the other one of the tensioning arm and the base body by means of a first axial bearing in a first direction and by means of a second axial bearing in a second direction, a first sealing element which is connected to the carrier portion for sealing the first axial bearing, a second sealing element which is connected to the carrier portion for sealing the second axial bearing, wherein the first and second axial bearings are made of a different material than the first and second sealing elements, spring means via which the tensioning arm is supported in the circumferential direction against the base body, and a tensioning roller which is rotatable mounted on the tensioning arm and serves to tension a traction means, wherein the first sealing element and the second sealing element are connected to one another by a plurality of connecting webs that extend through bores in the support portion.

The disclosed tensioning device has the advantage that the two sealing elements are positioned so as to be permanently fixed relative to the carrier portion through the connection via the connecting webs. A displacement of the sealing elements in the radial direction or in the circumferential direction, and in particular a complete loosening of the sealing portions from the carrier portion, is prevented, so that an increased operational lifetime of the sealing system and also of the bearing arrangement arises by the resulting permanent sealing effect. For this purpose, the number of bores in the carrier portion in which the connecting webs are arranged may be greater than 6, in particular greater than 12, and/or smaller than 24, in particular smaller than 18, in a possible embodiment.

The carrier portion carries the seals and can be formed on one of the base body or the tensioning arm. In one embodiment, the first sealing element and the second sealing element each comprise a closed profile ring and at least one sealing lip. The sealing lips, in particular two sealing lips, are in contact with a sliding sealing surface that is associated with the other part of the tensioning arm or the base body, so that a space between the base body and the tensioning arm is sealed from one side against environmental influences. The profile ring provides the sealing elements with stiffness in the radial direction and in the circumferential direction and serves to connect the sealing element with a second component in a force-, form- and/or material-locking manner. The material from which the sealing rings are made of can be from the group of thermoplastic elastomers, especially urethane-based thermoplastic elastomers, or a vulcanized rubber material. The bearing elements, however, are made of a different material than the sealing elements and may be made of a plastic based on polyamide or polyoxymethylene.

In a possible embodiment, the profile ring of the first sealing element is connected to the tensioning arm and the at least one sealing lip of the first sealing element abuts on the base body, wherein the profile ring of the second sealing element is also connected to the tensioning arm and the at least one sealing lip of the second sealing element also abuts on the base body. In another possible embodiment, the profile ring of the first sealing element is connected to the base body and the at least one sealing lip of the first sealing element abuts on the tensioning arm, wherein the profile ring of the second sealing element is also connected to the base body and the at least one sealing lip of the second sealing element also abuts on the tensioning arm. In both embodiments described above, the first and second sealing elements together seal a space in which the bearing arrangement of the tensioning device is located.

For positioning purposes, the first sealing element may be arranged in an annular first groove and the second sealing element may be arranged in an annular second groove, the first groove and the second groove being provided in opposite support faces of the carrier portion. Furthermore, the first sealing element can be connected form-fittingly to the first axial bearing and the second sealing element can be connected form-fittingly to the second axial bearing. For this purpose, the first sealing element and the first axial bearing as well as the second sealing element and the second axial bearing can each have a mutually complementary engagement structure.

A contactless seal can also be provided to seal the bearing arrangement additionally. For this purpose, the base body may have a first offset portion and the tensioning arm a second offset portion, wherein the first offset portion and the second offset portion are arranged radially outside the first sealing element with respect to the pivot axis and are aligned in the same direction so that an S-shaped gap is formed between the base body and the tensioning arm. The gap acts as a filter for coarse dirt particles larger in diameter than the width of the annular gap and protects the sealing elements from damage by these dirt particles. Furthermore, the gap acts as an axial labyrinth seal and can protect the installation space that is formed by the base body and the tensioning arm and in which the seal and bearing arrangement is located, from the entry of fluids such as splash water.

For pivotable mounting of the tensioning arm, at least one of the first axial bearing and the second axial bearing can be designed integrally with the radial bearing and can form a bearing unit. The bearing unit can be connected to the base body or the tensioning arm, in particular the bearing unit can be molded onto the base body or the tensioning arm. The bearing elements can be arranged on the carrier portion and on the one of the base body and tensioning arm that does not comprise the carrier portion. Integrating the individual bearing elements into one component reduces complexity during assembly of the tensioning device, decreasing the likelihood of assembly errors.

The spring means may comprise one or more spring elements, particularly in the form of a bending spring, such as a helical spring and/or spiral spring. The spring means can also be referred to as a spring element or spring. In the case of alternating loads as acting on the tensioning device, the spring means move in a radial direction with respect to their longitudinal axis. In the areas where the spring means rest on the base body or the tensioning arm, respectively, these movements can lead to wear and structural weakening of the spring means. In order to minimize the resulting damaging effect, in a possible embodiment, at least one of the base body and the tensioning arm can be provided with at least one wear protection element in an area which is engaged by the spring. The wear protection element can in particular be made of a plastic, for example of the same material as the bearing elements. In addition to plastic inserts, coatings such as hard material layers, carbon layers or passivating layers can also be applied.

### SUMMARY OF THE DRAWINGS

Example embodiments are explained below on the basis of the figures.

FIG. 1 shows a schematic representation of an exemplary tensioning device in an assembled condition in a traction drive in a perspective view;

FIG. 2 shows an exemplary tensioning device in a first embodiment in an exploded perspective view;

FIG. 3 shows the tensioning device according to FIG. 2 in a top view;

FIG. 4 shows the tensioning device according to FIG. 3 in a sectional view along the section line IV-IV;

FIG. 5 shows the tensioning device as shown in FIG. 4 in a cross section along the section line V-V;

FIG. 6 shows a detailed view of the detail Y of the tensioning device according to FIG. 4;

FIG. 7 shows an exemplary tensioning device in a second embodiment in an exploded perspective view;

FIG. 8 shows the tensioning device according to FIG. 7 in a top view;

FIG. 9 shows the tensioning device as shown in FIG. 8 in a longitudinal section along the section line IX-IX;

FIG. 10 shows the tensioning device as shown in FIG. 9 in a cross-section corresponding to the section line X-X; and

FIG. 11 shows a detailed view of the detail Z of the tensioning device according to FIG. 9.

### DESCRIPTION

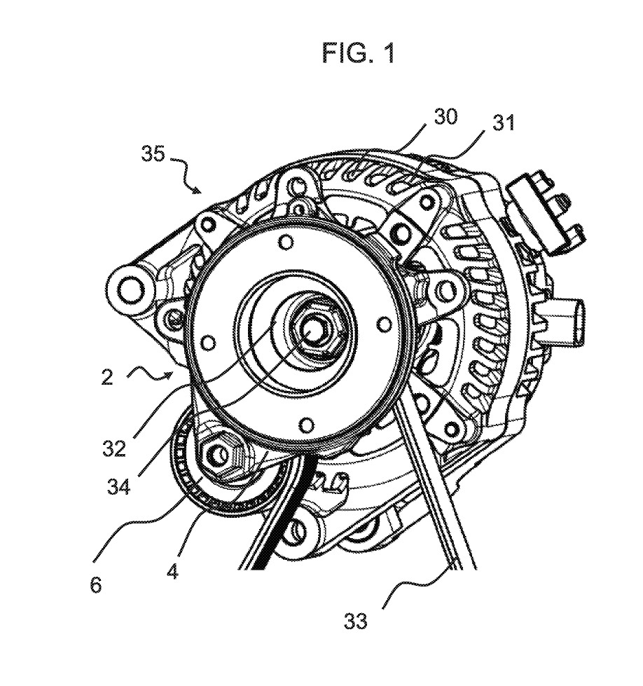

FIG. 1 schematically shows an exemplary tensioning device 2 for a traction drive in the form of a belt drive in a mounted condition on an accessory 30. Thereby, the tensioning device 2 and the accessory 30 constitute an accessory arrangement 35. The accessory 30 in the form shown is designed as a generator comprising a housing 31 that can be fastened to an engine block (not shown). It is understood, however, that the accessory 30 can also be any other working machine that is part of the traction drive, for example, a pump. The tensioning device 2 is attached to the front of the housing 31 of the accessory 30. A belt pulley 32 can be seen firmly connected to a drive shaft 34 of the accessory 30 via a screw connection. A belt 33 wraps around the belt pulley 32 and a tensioning roller 6 that is rotatable mounted on a tensioning arm 4. The belt 33 is pre-tensioned by the tensioning roller 6.

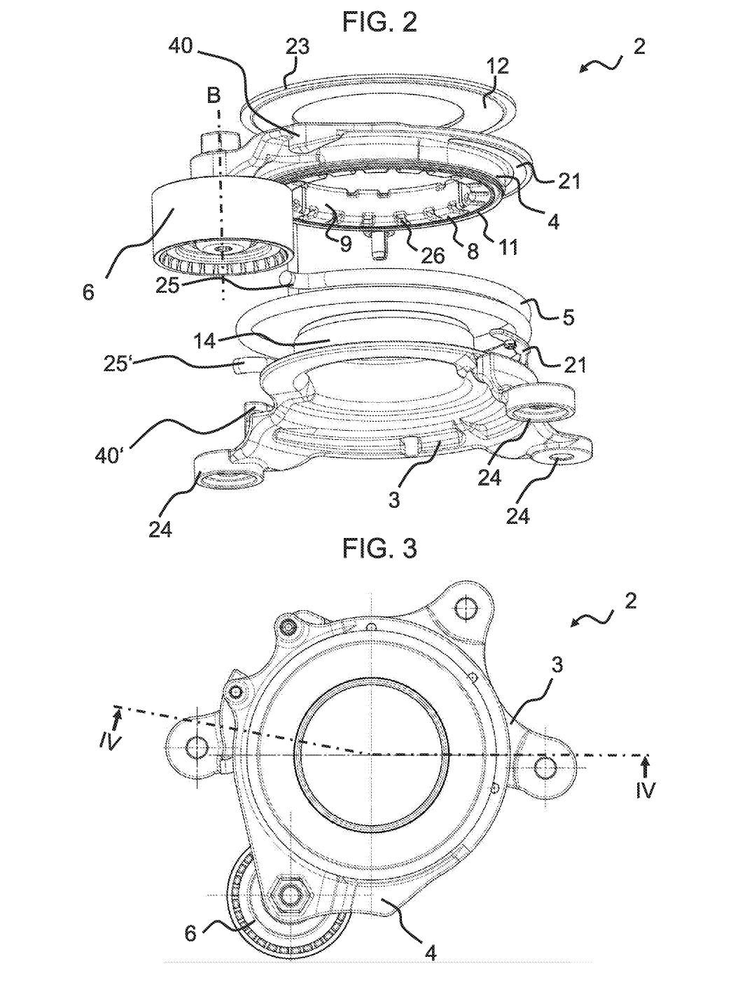

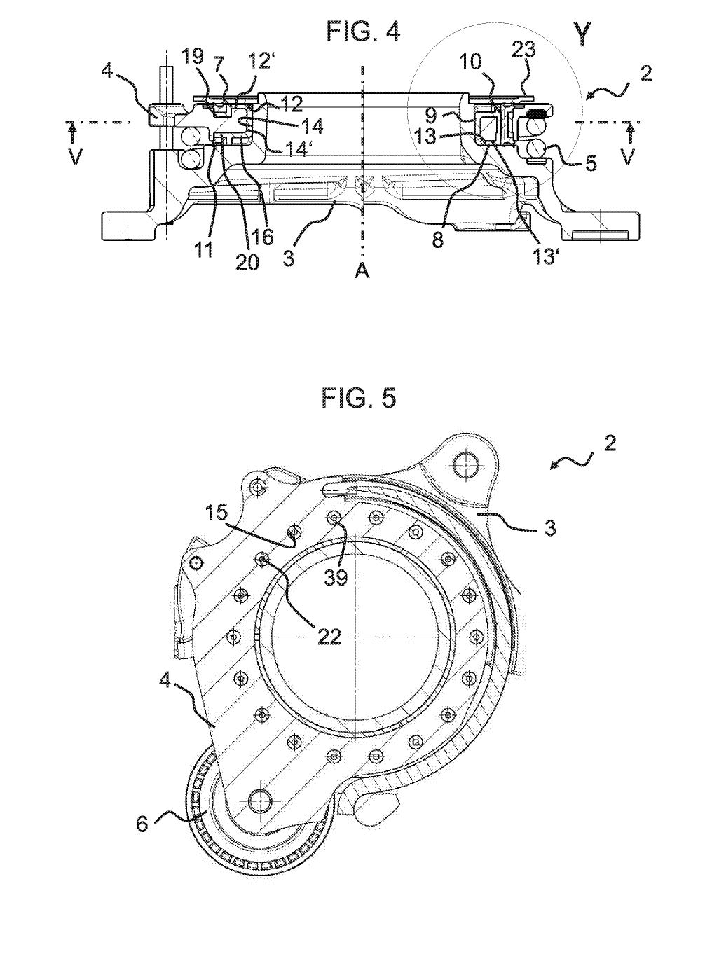

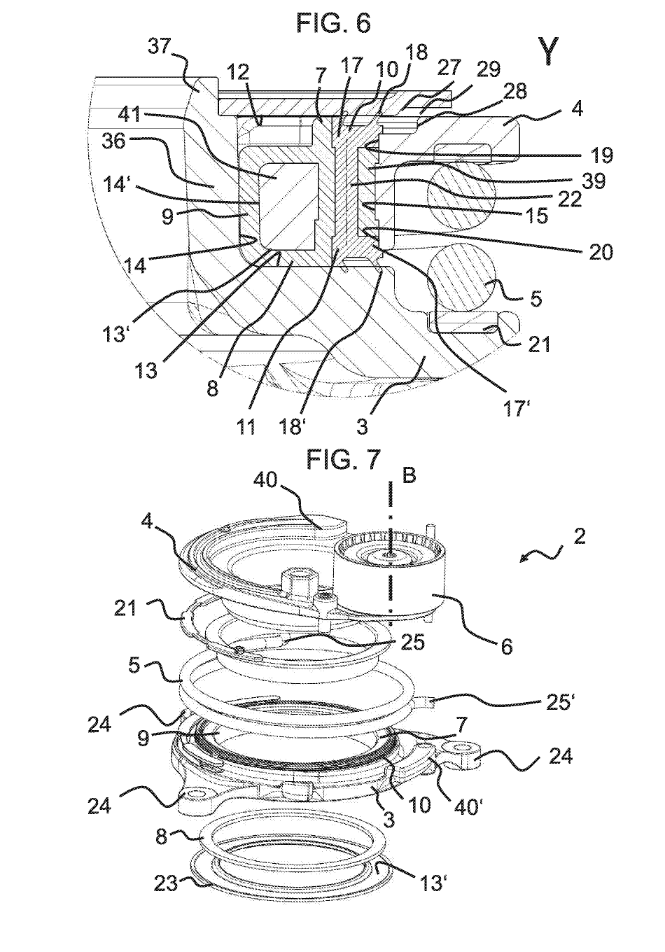

FIGS. 2 to 6, which are described together below, show an example tensioning device 2 in a first embodiment. The tensioning device comprises a base body 3 that can be connected to the housing 31 of the accessory 30, and a tensioning arm 4, that is pivotable mounted about a pivot axis A relative to the base body 3 and is resiliently supported on the base body 3 via spring means 5. The spring means 5 are designed as a helical spring, whereby it is to be understood that any other one or more spring elements can also be used, such as a spiral spring or bow spring. The pivotable mounting of the tensioning arm 4 is effected by a first axial bearing 7 that supports the tensioning arm 4 in a first axial direction, a second axial bearing 8 that supports the tensioning arm 4 in a second axial direction, and a radial bearing 9. The first axial bearing 7, the second axial bearing 8, and the radial bearing 9 are designed as a one-piece bearing unit 16 in the illustrated embodiment and molded onto a carrier portion 41 of the tensioning arm 4. To protect the bearing unit 16 from environmental influences, a first sealing element 10 and a second sealing element 11 are arranged radially on the outside of carrier portion 41. The first and the second sealing element 10, 11 are also directly molded onto the tensioning arm 4. On the tensioning arm 4, the tensioning roller 6 is mounted so that it can rotate about a rotational axis B that is parallel to the pivot axis A.

The base body 3 comprises three radially outwardly projecting connecting flanges 24, with bores through which connecting elements for fastening to the accessory 30 can be passed, a receiving portion 36 and an axial washer 23. The axial washer 23, which can also be referred to as an axial disc or plate, is firmly connected to the receiving portion 36. This is done by flanging a sleeve projection 37 of the receiving portion 36 after assembly of the spring element 5, the tensioning arm 4 with the bearing unit 16 connected hereto and the sealing elements 10, 11, and the axial washer 23. Embodiments are also conceivable in which the axial washer is connected to the receiving portion 36 via a screw connection or a press fit. In the illustrated embodiment, the base body 3 has a first support face 12 on the axial washer 23 and a second support face 13 on the receiving portion 36, as well as a radial contact face 14, which together form a circumferential, largely C-shaped cross-section, and by which an outwardly open, annular installation space, in which the tensioning arm 4 is arranged, is partially delimited.

The spring element 5 is supported with one spring end 25 on the side of the tensioning arm 4 against a support shoulder 40 and with another spring end 25′ on the side of the base body 3 against a support shoulder 40′. By pivoting the tensioning arm 4 relative to the base body 3, the spring element 5 is pretensioned. The spring element 5 thus applies a torque to the tensioning arm 4 to reset the pivot movement. The tensioning device 2 is mounted in a belt drive in a pivoted condition so that the resetting torque acts as a pretensioning force on the belt 33.

The first axial bearing 7 is arranged between a first support face 12′ of the tensioning arm 4 and the first support face 12 of the base body 3. The second axial bearing 8 is arranged between a second support face 13′ of the tensioning arm 4 and the second support face 13 of the base body 3. The radial bearing 9 is arranged between a radial contact face 14′ of the tensioning arm 4 and a radial contact face 14 of the base body 3. The first support face 12′, the second support face 13′ as well as the radial contact face 14′ are partly interrupted by recesses 26 that can be provided to save material. In the illustrated embodiment, the first support face 12′ and the second support face 13′ each lie in exactly one plane. It is also possible that the surfaces of the first support face each include partial areas that are located in different parallel planes and in particular are separated from each other by shoulders.

The first sealing element 10 and the second sealing element 11 are arranged radially outside the bearing unit 16 and each comprise a profile ring 17, 17′ and two sealing lips 18, 18′. The first sealing element 10 is located with the profile ring 17 in a first annular groove 19 that is worked into the first support face 12′ of the tensioning arm 4. The second sealing element 11 is located with the profile ring 17′ in a second annular groove 20, that is worked into the second support face 13′ of the tensioning arm 4. The sealing lips 18 are in contact with the first support face 12, the sealing lips 18′ are in contact with the second support face 13, thus sealing together the space in which the bearing unit 16 is arranged.

The one-piece bearing unit 16, comprising a polyamide-based plastic, is first molded onto the tensioning arm 4, wherein the first axial bearing 7 and the second axial bearing 8 are connected to each other via connecting hollow cylinders 39 in bores 15 of the tensioning arm 4. The connecting hollow cylinders 39 are arranged in the axial direction in the region of the carrier portion 41. The first sealing element 10 and the second sealing element 11, each comprising a thermoplastic elastomer, are molded onto the semi-finished product consisting of tensioning arm 4 and bearing unit 16 in a further process step. The first sealing element 10 and the second sealing element 11 are connected to each other via connecting webs 22 in the bores 15 of the tensioning arm 4. In the illustrated embodiment, the connecting webs 22 extend through the connecting hollow cylinders 39. Alternatively, it is also possible that the two injection processes are carried out such that only the connecting webs 22 are accommodated in the bores 15. The illustrated embodiment comprises eighteen bores 15 that are provided in the carrier portion 41 of the tensioning arm 4 evenly distributed along a circumference, and each accommodate a connecting hollow cylinder 39 and a connecting web 22. It is understood that a different number of connecting webs 22 can also be used.

An additional sealing of the bearing unit 16 upstream of the first sealing element 10 and the second sealing element 11 is achieved by a lateral sealing through a ring gap 29. The ring gap 29 is formed by a first offset portion 27 of the axial washer 23 and a second offset portion 28 of the tensioning arm 4 and acts as a filter for coarse dirt particles and protects the sealing elements 10 and 11 from damage. Furthermore, the ring gap 29 acts like a labyrinth seal, that can restrict the entry of fluids, such as splash water, into the installation space in which sealing elements 10, 11, and the bearing unit 16 are arranged.

To protect the spring element 5 against wear due to relative movements relative to the base body 3 and the tensioning arm 4, wear protection elements 21 are arranged in the contact areas on the base body 3 and the tensioning arm 4. The wear protection elements 21 are designed as plastic inserts that can be replaced in case of progressive wear. In particular, the wear protection elements 21 are made of the same material as the bearing unit 16.

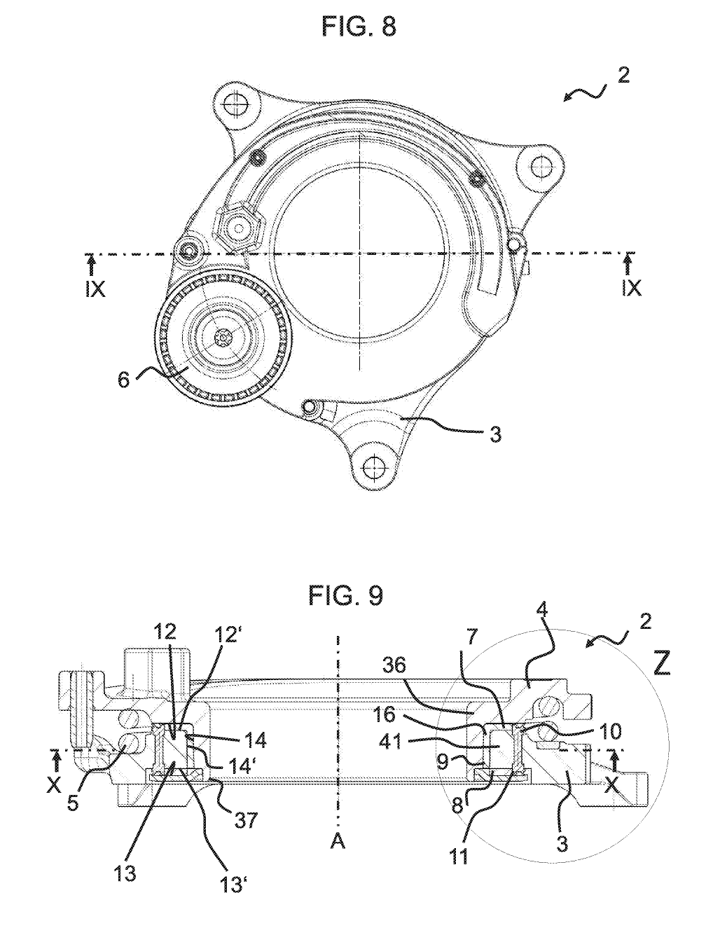

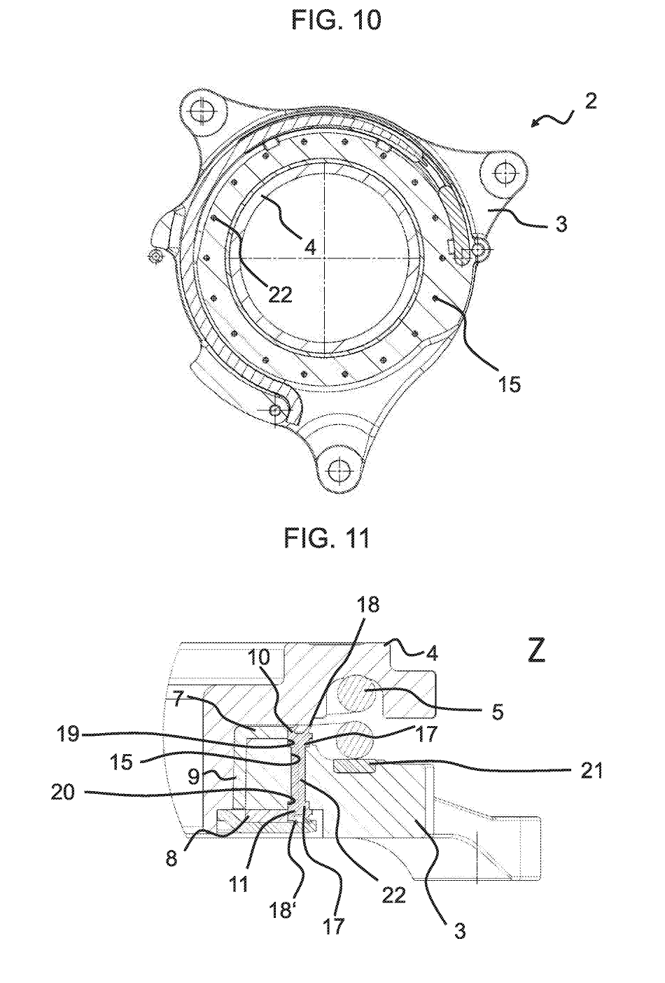

FIGS. 7 to 11, which are described together below, show an example tensioning device 2 in a second embodiment. The tensioning device comprises a base body 3 that can be connected to the housing 31 of the accessory 30 via three connecting flanges 24 by fastening means, a tensioning arm 4, which is pivotable mounted about a pivot axis A relative to the base body 3 and is supported elastically against the base body 3 via spring means 5. The spring means 5 here are also designed as coil springs but other spring means could be used. The pivotable mounting of the tensioning arm 4 is carried out by a first axial bearing 7 that supports the tensioning arm 4 in a first axial direction, a second axial bearing 8 that supports the tensioning arm 4 in a second axial direction, and a radial bearing 9. In the illustrated embodiment, the first axial bearing 7 and the radial bearing 9 are designed as a one-piece bearing unit 16, that is molded onto a carrier portion 41 of the base body 3. The second axial bearing 8 is a separate axial washer. To protect the bearing unit 16 and the second axial bearing 8 from environmental influences, a first sealing element 10 and a second sealing element 11 are arranged radially outside on the carrier portion 41. The sealing elements 10, 11 are molded directly onto the base body 3.

The tensioning arm 4 has a tensioning roller 6, that is mounted so as to be rotatable about an rotational axis parallel to the pivot axis A, a receiving portion 36 and an axial washer 23. The axial washer 23 is firmly connected to the receiving portion 36. This is done by flanging a sleeve projection 37 of the receiving portion 36 after mounting the spring element 5, the base body 4 with the bearing unit 16 and the sealing elements 10, 11 connected to it, the second axial bearing 8 and the axial washer 23. In the illustrated embodiment, the tensioning arm 4 has a first support face 12 and a radial contact face 14 at the receiving portion 36 and a second support face 13 at the thrust washer 23, which together form a circumferential, substantially C-shaped cross-section and partly delimits an outwardly open, annular installation space in which the base body 3 is arranged.

The spring element 5 is supported with one spring end 25 on the side of the tensioning arm 4 on a support shoulder 40 and with another spring end 25′ on the side of the base body 3 on a support shoulder 40′. By pivoting the tensioning arm 4 relative to the base body 3, the spring element 5 is pretensioned. The spring element 5 thus applies a torque to the tensioning arm 4 to reset the pivot movement. The tensioning device 2 is mounted in a belt drive in a pivoted condition so that the resetting torque acts as a pretensioning force on the belt 33.

The first axial bearing 7 is arranged between the first support face 12 of the tensioning arm 4 and a first support face 12′ of the base body 3. The second axial bearing 8 is arranged between the second support face 13 of the tensioning arm 4 and a second support face 13′ of the base body 3. The radial bearing 9 is arranged between the radial contact face 14 of the tensioning arm 4 and a radial contact face 14′ of the base body 3.

The first sealing element 10 and the second sealing element 11 are arranged radially outside the bearing unit 16 and the second axial bearing 8, and each comprises a profile ring 17, 17′ and two sealing lips 18, 18′. The first sealing element 10 sits with the profile ring 17 in a first annular groove 19 worked into the first support face 12′ of the base body 3. The second sealing element 11 sits with the profile ring 17′ in a second annular groove 20 worked into the second supporting surface 13′ of the base body 3. The sealing lips 18 are in contact with the first support face 12 of the tensioning arm 4, and the sealing lips 18′ are in contact with the second support face 13 of the tensioning arm 4 and thus jointly seal the space in which the bearing unit 16 and the second axial bearing 8 are arranged.

The first sealing element 10 and the second sealing element 11 are molded onto the semi-finished product consisting of base body 3 and bearing unit 16 in one process step. The first sealing element 10 and the second sealing element 11 are connected to each other via connecting webs 22 in the bores 15 of the base body 3. The illustrated embodiment here comprises eighteen bores 15, that are distributed evenly over a circumference in the carrier portion 41 of the base body 3. It is to be understood that a different number of connecting webs 22 can also be used.

To protect the spring element 5 against wear due to relative movements with respect to the base body 3 and the tensioning arm 4, wear protection elements 21 are arranged in the contact areas on the base body 3 and the tensioning arm 4. The wear protection elements 21 are designed as plastic inserts that can be replaced in case of progressive wear.

### REFERENCE SIGN LIST

2 tensioning device
3 base body
4 tensioning arm
5 spring means
6 tensioning roller
7 first axial bearing
8 second axial bearing
9 radial bearing
10 first sealing element
11 second sealing element
12, 12′ first support face
13, 13′ second support face
14, 14′ radial contact face
15 bore
16 bearing unit
17, 17′ profile ring
18, 18′ sealing lip
19 first groove
20 second groove
21 wear protection element
22 connecting web
23 axial washer
24 connecting flange
25, 25′ spring ends
26 recesses
27 first offset portion
28 second offset portion
29 ring gap
30 accessory
31 housing
32 belt roller
33 belt/traction means
34 drive shaft
35 accessory arrangement
36 receiving portion
37 sleeve projection
38
39 connecting hollow cylinder
40, 40′ support shoulder
41 carrier portion
A pivot axis
B rotational axis

1.-14. (canceled)

15. A tensioning device for a traction drive comprising:
a base body,
a tensioning arm which is pivotably mounted about a pivot axis relative to the base body by a radial bearing,
wherein one of the base body and tensioning arm has an annular carrier portion which is axially supported relative to the other one of the tensioning arm and base body by a first axial bearing in a first direction and by a second axial bearing in a second direction,
a first sealing element connected to said carrier portion for sealing said first axial bearing,
a second sealing element connected to said carrier portion for sealing said second axial bearing,
wherein the first and second axial bearings are made of a different material than the first and second sealing elements,
at least one spring by which the tensioning arm is supported in a circumferential direction against the base body, and
a tensioning roller which is rotatably mounted on the tensioning arm and is configured to tension a traction means,
wherein the first sealing element and the second sealing element are connected to one another by a plurality of connecting webs that extend through bores in the carrier portion.

16. The tensioning device according to claim 15,
wherein the first and the second sealing element are made of a material selected from thermoplastics and a vulcanized rubber material.

17. The tensioning device according to claim 15,
wherein the first and second axial bearings are made of a plastic based on polyamide or polyoxymethylene.

18. The tensioning device according to claim 15,
wherein the first sealing element is form-fittingly connected to the first axial bearing, and the second sealing element is form-fittingly connected to the second axial bearing.

19. The tensioning device according to claim 18,
wherein the first sealing element and the first axial bearing have a mutually complementary first engagement structure, and wherein the second sealing element and the second axial bearing have a mutually complementary second engagement structure.

20. The tensioning device according to claim 15,
wherein at least one of the first axial bearing and the second axial bearing is integral with the radial bearing and jointly form a bearing unit.

21. The tensioning device according to claim 20,
wherein the bearing unit is connected to the base body or the tensioning arm by injection-molding.

22. The tensioning device according to claim 15,
wherein the first sealing element and the second sealing element each have a closed profile ring and at least one sealing lip.

23. The tensioning device according to claim 22,
wherein the profile ring of the first sealing element is connected to the tensioning arm, and the at least one sealing lip of the first sealing element is in contact with the base body, and
wherein the profile ring of the second sealing element is connected to the tensioning arm, and the at least one sealing lip of the second sealing element is in contact with the base body.

24. The tensioning device according to claim 22,
wherein the profile ring of the first sealing element is connected to the base body, and the at least one sealing lip of the first sealing element is in contact with the tensioning arm, and
wherein the profile ring of the second sealing element is connected to the base body, and the at least one sealing lip of the second sealing element is in contact with the tensioning arm.

25. The tensioning device according to claim 15,
wherein the first sealing element is arranged in an annular first groove and the second sealing element is arranged in an annular second groove, the first groove and the second groove being provided in opposite supporting surfaces of the carrier portion.

26. The tensioning device according to claim 15,
wherein the base body has a first offset portion and the tensioning arm has a second offset portion,
wherein the first offset portion and the second offset portion are arranged radially externally of the first sealing element with respect to the pivot axis and are formed in such a way that an S-shaped annular gap is formed between the base body and the tensioning arm.

27. The tensioning device according to claim 15,
wherein at least one of the base body and the tensioning arm has, in a region that is engaged by the spring means, at least one wear protection element.

28. The tensioning device according to claim 15,
wherein the number of bores in the carrier portion is greater than 6.

29. The tensioning device according to claim 15,
wherein the number of bores in the carrier portion is smaller than 24.
